(19) United States
(12) Patent Application Publication
(10) Pub. No.: US 2012/0240173 A1
(43) Pub. Date: Sep. 20, 2012

(54) VIDEO SIGNAL PROCESSING CIRCUIT AND METHOD APPLICABLE THERETO

(75) Inventor: Hsin-I LIN, Yilan County (TW)

(73) Assignee: NOVATEK MICROELECTRONICS CORP., Hsinchu (TW)

(21) Appl. No.: 13/339,090

(22) Filed: Dec. 28, 2011

(30) Foreign Application Priority Data
Mar. 15, 2011 (TW) 100108825

(51) Int. Cl. H04N 21/60

(52) U.S. Cl. 725/109

(57) ABSTRACT

A video signal processing circuit includes: a transport stream (TS) decoding unit, decoding a demodulated analog radio frequency (RF) signal for generating a first TS signal; and a TS bit rate control unit, deciding whether to insert a null packet stream into the first TS signal to generate a second TS signal.

This application claims the benefit of Taiwan application Serial No. 100108825, filed Mar. 15, 2011, the subject matter of which is incorporated herein by reference.

### TECHNICAL FIELD

The disclosure relates in general to a video signal processing circuit and a method applicable thereto.

### BACKGROUND

TV has become an indispensible electronic product to people in their everydayness. Currently, digital TV has attracted even more interests due to its high resolution and delicacy, anti-interference capacity, which protects the frame quality from weather interference, and a variety of interactive functions and software upgrading functions.

TVs capable of receiving and processing external digital TV signals or TVs with an internal digital TV decoder are normally referred as digital TVs. Despite that TVs capable of receiving and processing the external digital TV signals have become more and more popular, many households still use analog TVs that can only receive analog TV signals. If users decide to continue to use the analog TV which can only receive analog TV signals, a digital TV set-top box needs to be disposed on the analog TV for converting digital TV signals into analog TV signals. By doing so, the analog TV is able to receive the digital TV signals.

The digital TV set-top box converts digital TV signals into analog signals, and further demodulates, decompresses and digital-to-analog converts into video signals that are visible to human eyes.

During the video signal processing of the digital TV set-top box, if the bit rate of the transport stream (TS) is not stable, it is possible that subsequent processing (such as the descrambling operation) may be interrupted or erred.

### BRIEF SUMMARY

The disclosure is directed to a video signal processing circuit and a method applicable thereto for maintaining/changing the bit rate of the TS signal.

According to one embodiment of the present disclosure, a video signal processing circuit including a transport stream (TS) decoding unit and a TS bit rate control unit is provided. The TS decoding unit is for decoding a demodulated analog radio frequency (RF) signal to generate a first TS signal. The TS bit rate control unit is for determining whether to insert a null packet stream to the first TS signal to generate a second TS signal according to the bit rate of the first TS signal.

According to another embodiment of the present disclosure, a video signal processing method is provided. The method includes the following steps. A demodulated analog RF signal is decoded to generate a first TS signal. Whether to insert a null packet stream to the first TS signal to generate a second TS signal is determined according to a bit rate of the first TS signal.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 shows a function diagram of a video signal processing circuit according to an embodiment of the present disclosure;

FIG. 2 shows a block diagram of a TS bit rate control unit according to the embodiment of the present disclosure;

FIG. 3 shows a function block diagram of a control logic circuit according to the embodiment of the present disclosure;

FIG. 4A shows a signal timing diagram of a write control signal generation unit according to the embodiment of the present disclosure;

FIG. 4B shows a signal timing diagram of a write address generation unit according to the embodiment of the present disclosure;

FIG. 4C shows a signal timing diagram of a read control signal generation unit according to the embodiment of the present disclosure;

FIG. 4D shows a signal timing diagram of a read address generation unit according to the embodiment of the present disclosure;

FIG. 4E shows a signal timing diagram of an available packet number indicator according to the embodiment of the present disclosure

FIG. 4F shows a signal timing diagram of an output packet generation unit according to the embodiment of the present disclosure;

FIG. 4G shows a signal timing diagram of a clock generation unit according to the embodiment of the present disclosure;

FIG. 5 shows a schematic diagram of an FSM according to the embodiment of the present disclosure;

FIG. 6A shows a signal timing diagram of a determination unit according to the embodiment of the present disclosure;

FIG. 6B shows a signal timing diagram of a packet output number counter according to the embodiment of the present disclosure;

FIG. 6C shows a signal timing diagram of a wait period counter according to the embodiment of the present disclosure;

FIG. 6D shows a signal timing diagram of an FSM control unit according to the embodiment of the present disclosure; and

FIG. 6E shows a signal timing diagram of a data validity indicator according to the embodiment of the present disclosure.

### DETAILED DESCRIPTION OF THE DISCLOSURE

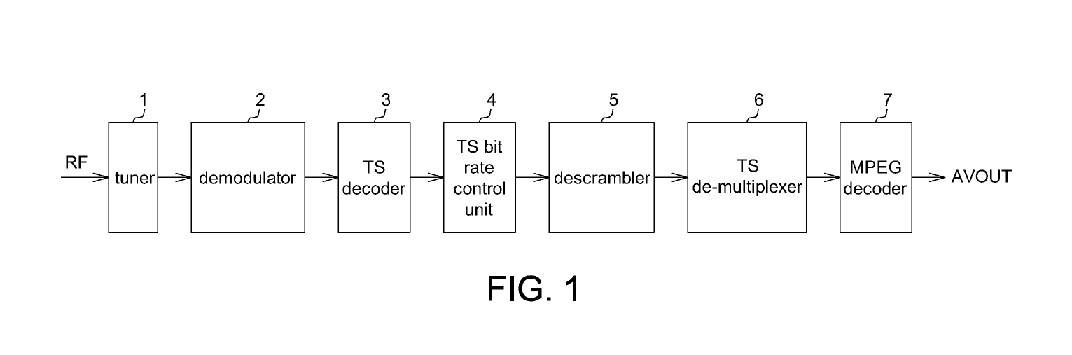

FIG. 1 shows a function diagram of a video signal processing circuit according to an embodiment of the present disclosure. As indicated in FIG. 1, the video signal processing circuit includes a tuner 1, a demodulator 2, a transport stream (TS) decoder 3, a TS bit rate control unit 4, a descrambler 5, a TS de-multiplexer 6 and an MPEG decoder 7.

The tuner 1 receives an analog radio frequency (RF) signal RF, down-converts the radio frequency signal RF such as from a high frequency (such as but not limited to 200˜800 MHz) to a middle frequency (such as but not limited to around 36 MHz), and transfers to the demodulator 2.

The demodulator 2 performs demodulation (such as channel calibration, channel synchronization, debugging, and channel encoding) on the signal, and outputs to the TS decoder 3. The TS decoder 3 performs TS decoding on the output signal of the demodulator 2.

The TS bit rate control unit 4 may change the bit rate of the TS signal, and outputs a bit-rate-changed TS signal to the descrambler 5, which further perform descrambling. The TS de-multiplexer 6 performs descrambling on the output signal of the descrambler 5, and outputs to the MPEG decoder 7, which generates analog video signals AVOUT visible to human eyes.

The operations of the TS bit rate control unit 4 according to the embodiment of the present disclosure are disclosed below for explaining how the TS bit rate control unit 4 changes the bit rate of the TS signal.

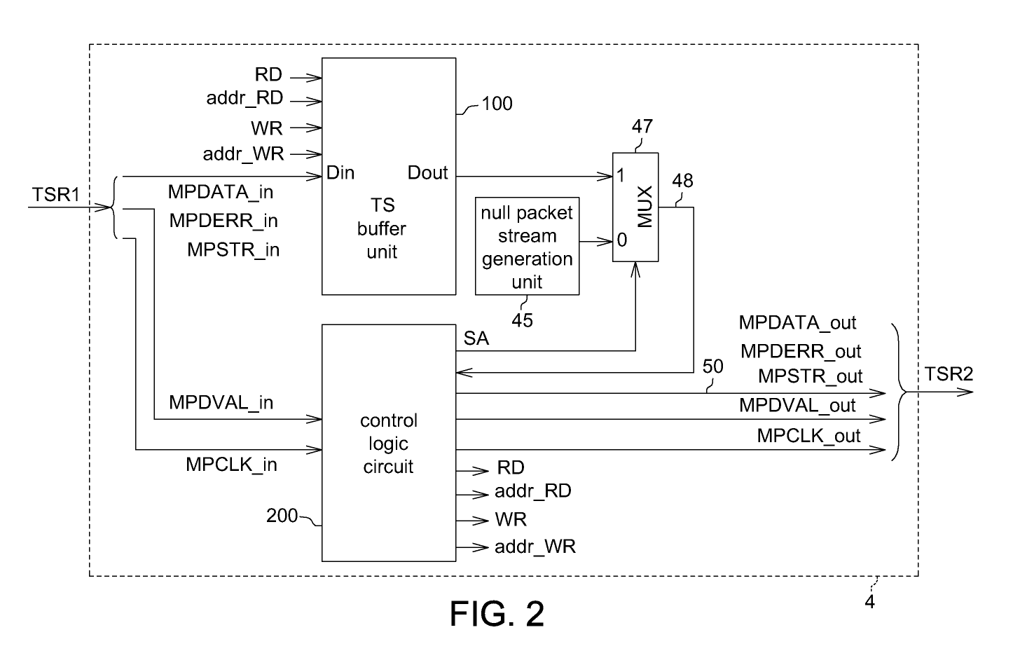

Referring to FIG. 2, a block diagram of the TS bit rate control unit 4 according to the embodiment of the present disclosure is shown. As indicated in FIG. 2, the TS bit rate control unit 4 includes a TS buffer unit 100, a null packet stream generation unit 45, a multiplexer 47 and a control logic circuit 200. The TS bit rate control unit 4 changes the bit rate of the TS signal. That is, the TS bit rate control unit 4 generates a signal TSR2 from the signal TSR1, wherein, the signal TSR1 and the signal TSR2 both are TS signals but have different bit rates. The TS signal includes signals MPDATA, MPERR, MPSTR, MPDVAL and MPCLK. The signal MPDATA denotes data; the signal MPERR denotes whether data has error; the signal MPSRT denotes a data header; the signal MPDVAL denotes whether data is valid; and the signal MPCLK is a clock signal of the signal TS. In the present disclosure, the signals MPDATA, MPERR, MPSTR are referred as the packet signals of the signal TS.

The TS buffer unit 100 is implemented by such as but is not limited to a dual-port SRAM. In an alternative implementation, the TS buffer unit 100 may be realized by a circular buffer. The read control signal RD, generated by the control logic circuit 200, is for controlling the TS buffer unit 100 to perform a read operation. The address signal addr_RD is a read address. The write control signal WR, generated by the control logic circuit 200, is for controlling the TS buffer unit 100 to perform a write operation. The address signal addr_WR is a write address.

Packets of the signal TSR2 may be provided by the TS buffer unit 100 or by the null packet stream generation unit 45. The null packet stream generation unit 45 provides null packet streams. If the number of available packets buffered in the TS buffer unit 100 is larger than a threshold T, then the packets of the signal TSR2 are provided by the TS buffer unit 100, otherwise, the packets of the signal TSR2 are provided by the null packet stream generation unit 45.

The multiplexer 47 is controlled by a signal SA generated by the control logic circuit 200 to select the packets (including such as signals MPDATA_out, MPERR_out and MPSTR_out) of the signal TSR2 are either provided by the TS buffer unit 100 or by the null packet stream generation unit 45. That is, the control logic circuit 200 generates the signal SA according to whether the number of available packets buffered in the TS buffer unit 100 is sufficient (that is, larger than threshold T) to control the multiplexer 47 to output the signals (i.e. the packets of the signal TSR1, at least including signals MPDATA_in, MPERR_in and MPSTR_in) provided by the TS buffer unit 100 or to output the null packet streams provided by the null packet stream generation unit 45. The output signal of the multiplexer 47 is designated as 48.

The control logic circuit 200 generates the signals RD, addr_RD, WR and addr_WR according to the signals MPDVAL_in and MPCLK_in of the signal TSR1. The control logic circuit 200 generates the signal SA according to the control signals RD and WR for controlling the multiplexer 47. The control logic 200 generates a signal 50 from the output signal 48 of the multiplexer 47 (for example, latching the signal 48 into the signal 50), and uses the signal 50 as the packets of the signal TSR2. The control logic 200 further generates signals MPDVAL_out and MPCLK_out.

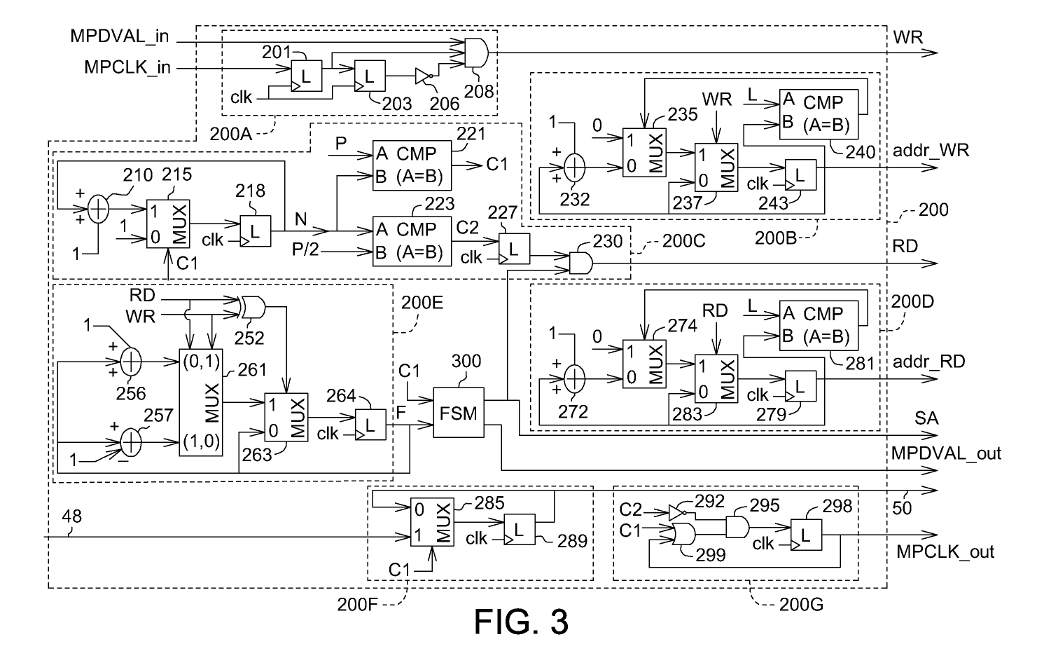

Referring to FIG. 3, a function block diagram of the control logic circuit 200 according to the embodiment of the present disclosure is shown. The control logic 200 includes a write control signal generation unit 200A, a write address generation unit 200B, a read control signal generation unit 200C, a read address generation unit 200D, an available packet number indicator 200E, an output packet generation unit 200F, a clock generation unit 200G and a finite state machine (FSM) 300.

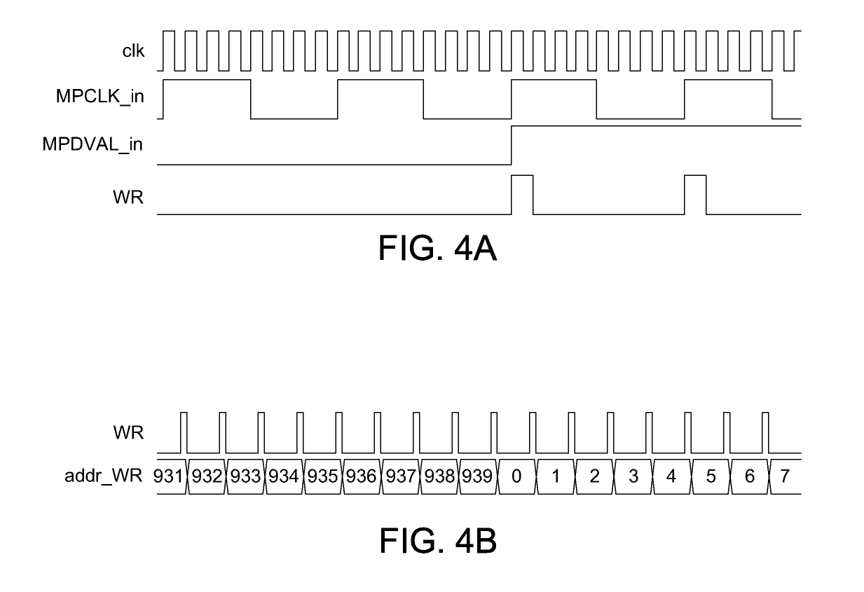

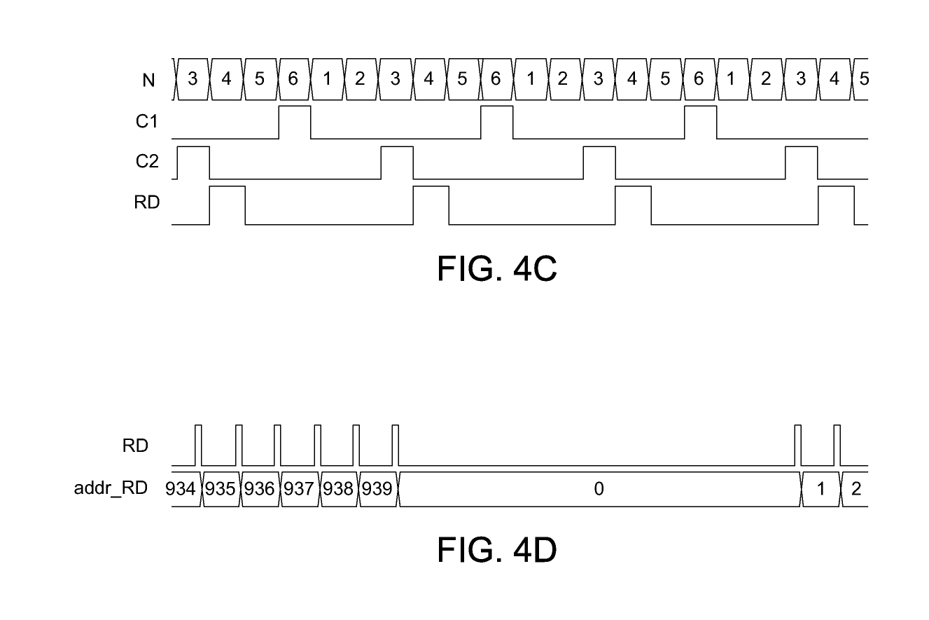

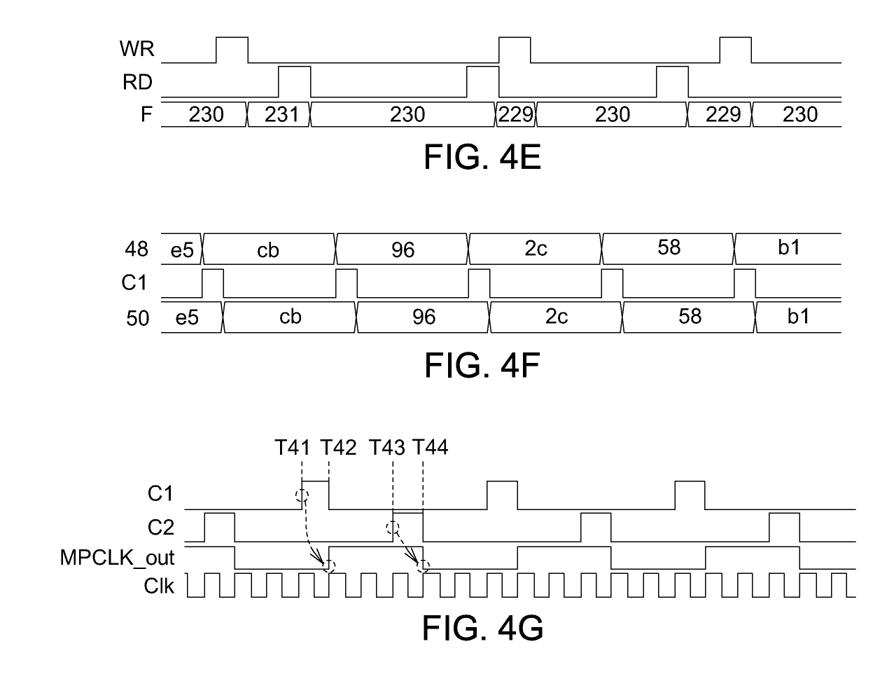

FIG. 4A shows a signal timing diagram of the write control signal generation unit 200A according to the embodiment of the present disclosure. The write control signal generation unit 200A generates the write control signal WR. Referring to FIG. 3 and FIG. 4A. The write control signal generation unit 200A includes latches 201 and 203, and logic gates 206 and 208. Here, the logic gates 206 and 208 are such as but are not limited to an inverter logic gate and an OR logic gate. The latch 201 latches the clock signal MPCLK_in according to a clock signal clk, and the output signal of the latch 201 is outputted to the latch 203 and the logic gate 208. The latch 203 latches the input signal (that is, the output signal of the latch 201) according to the clock signal clk, and outputs to the logic gate 206. The logic gate 206 inverts the output signal of the latch 203, and outputs to the logic gate 208. The logic gate 208 performs a logic computation on the signal MPDVAL_in, the output signal of the latch 201 and the output signal of the logic gate 206 to generate the write control signal WR. The output signal of the latch 201 may be regarded as a sampling signal of the clock signal MPCLK_in, and is behind the clock signal MPCLK_in by one period of the clock signal clk. The output signal of the latch 203 may be regarded as a sampling signal of the clock signal MPCLK_in, and is behind the clock signal MPCLK_in by two periods of the clock signal clk.

As indicated in FIG. 4A, when signal MPDVAL_in is valid (such as but not limited to logic high), in the embodiment of the present disclosure, the write control signal WR is generated in response to the rising edge of the signal MPCLK_in, and the pulse width of the write control signal WR equals one period of the clock signal clk.

FIG. 4B shows a signal timing diagram of the write address generation unit 200B according to the embodiment of the present disclosure. The write address generation unit 200B generates the write address addr_WR. Referring to FIG. 3 and FIG. 4B. The write address generation unit 200B includes an adder 232, multiplexers 235 and 237, a latch 243, and a comparer 240. A parameter L, which denotes the size of the TS buffer unit 100 (that is the upper limit of the write address addr_WR), is such as but is not limited to 939 (L=939). The parameter L increases if the capacity of the TS buffer unit 100 increases, and vice versa.

The TS buffer unit 100 is exemplified by a circular buffer. When the write address addr_WR reaches the parameter L (that is, addr_WR=L), the comparer 240 outputs logic 0, such that the multiplexer 235 selects “0” to the multiplexer 237 and the latch 243 to reset the write address addr_WR. To the contrary, if the write address addr_WR has not yet reached the value of the parameter L (that is, addr_WR<L), the comparer 240 outputs logic 1, such that the multiplexer 235 selects the output signal “addr_WR+1” of the adder 232 to the multiplexer 237 and the latch 243 to progressively increase the write address addr_WR. Thus, when the write control signal WR occurs, the write address addr_WR is progressively increased until the write address addr_WR is equal to the upper limit L. To put it in greater details, when the write address addr_WR has not yet reached the upper limit L, the multiplexer 235 outputs the add result “addr_WR+1” of the adder 232, and when the write control signal WR occurs, the multiplexer 237 outputs the output signal “addr_WR+1” of the multiplexer 235 to the latch 243. Triggered by the clock signal clk, the latch 243 outputs the progressively increased write address addr_W R.

FIG. 4C shows a signal timing diagram of the read control signal generation unit 200C according to the embodiment of the present disclosure. The read control signal generation unit 200C generates the read control signal RD. Referring to FIG. 3 and FIG. 4C. The read control signal generation unit 200C includes an adder 210, a multiplexer 215, latches 218 and 227, a logic gate 230, and comparers 221 and 223. The adder 210, the multiplexer 215 and the latch 218 form a progressively increasing unit which increases a parameter N. To put it in greater details, the adder 210 outputs “N+1” to the multiplexer 215. When the signal C1 is logic 0, the multiplexer 215 outputs “N+1” to the latch 218. Triggered by the clock clk, the latch 218 outputs “N+1”. When signal C1 is logic 1, the multiplexer 215 outputs 1 to the latch 218 to reset “N” as 1. A parameter P denotes the ratio of the period of the clock signal MPCLK_out to the period of the clock signal clk (that is, P=MPCLK_out/clk), and is exemplified by 6 (P=6). The comparer 221 compares “N” to “P”. When “N” and “P” are the same, the comparer 221 outputs a logic-1 signal C1, and vice versa. The comparer 223 compares “N” to “P/2”. When “N” and “P/2” are the same, the comparer 223 outputs a logic-1 signal C2, and vice versa. That is, when N=3, the signal C2 is logic 1; otherwise, the signal C2 is logic 0. The latch 227 latches the signal C2. The logic gate 230 performs an AND logic operation on the signal SA and the output signal of the latch 227 to generate the read control signal RD. As known from the above elaboration and FIG. 4C, the signal C2 is logic 1 when N=3, and given that signal SA=1, the read control signal RD is generated in response to a trigger by the clock clk.

FIG. 4D shows a signal timing diagram of the read address generation unit 200D according to the embodiment of the present disclosure. The read address generation unit 200D generates the read address addr_RD. Referring to FIG. 3 and FIG. 4D. The read address generation unit 200D includes an adder 272, multiplexers 274 and 283, a latch 279, and a comparer 281. The parameter L, which also denotes the upper limit of the read address addr_RD, is exemplified by 939 (L=939) but is not limited thereto. When the read address addr_RD reaches the value of the parameter L (addr_RD=L), the comparer 281 outputs logic 0, so that the multiplexer 274 selects “0” to the multiplexer 283 and the latch 279 to reset addr_RD. To the contrary, if the read address addr_RD has not yet reached the value of the parameter L (that is, addr_RD<L), the comparer 281 outputs logic 1, such that the multiplexer 274 selects the output “1+addr_RD” of the adder 272 to the multiplexer 283 and the latch 279 to progressively increase the read address addr_RD. Thus, when the read control signal RD occurs, the read address addr_RD is progressively increased until the read address addr_RD is equal to the upper limit L. To put it in greater details, when the read address addr_RD has not yet reached the upper limit L, the multiplexer 274 outputs the addition result “1+addr_RD” of the adder 272, and when the read control signal RD occurs, the multiplexer 283 outputs the signal “1+addr_RD” outputted by the multiplexer 274 to the latch 279. Triggered by the clock signal clk, the latch 279 outputs the progressively increased read address addr_RD.

FIG. 4E shows a signal timing diagram of the available packet number indicator 200E according to the embodiment of the present disclosure. The available packet number indicator 200E indicates the number of available packets buffered in the TS buffer unit 100. Referring to FIG. 3 and FIG. 4E. The available packet number indicator 200E includes adders 256 and 257, multiplexers 261 and 263, a latch 264, and a logic gate 252. The adder 256 adds a signal “F” by 1, and the adder 257 decreases the signal “F” by 1. The signal “F” denotes the number of currently available packets buffered in the TS buffer unit 100.

The multiplexer 261 is controlled by the control signals RD and WR. When the control signals RD and WR are respectively 0 and 1 (that is, when data is written to the TS buffer unit 100), the multiplexer 261 selects “F+1” (that is, the result of addition computation performed by the adder 256) to the multiplexer 263. Since the output signal of the logic gate 252 is logic 1, the multiplexer 263 selects the output signal “F+1” of the multiplexer 261 to the latch 264. Triggered by the clock signal clk, the latch 264 outputs the signal “F+1”, such that the signal “F” is added by 1. That is, when the packet is written to the TS buffer unit 100, one more available packet is buffered in the TS buffer unit 100, so the signal “F” is added by 1.

To the contrary, when the control signals RD and WR are respectively 1 and 0 (that is, when data is read from the TS buffer unit 100), the multiplexer 261 selects “F−1” (that is, the result of addition computation performed by the adder 257) to the multiplexer 263. Since the output signal of the logic gate 252 is logic 1, the multiplexer 263 selects the output signal “F−1” of the multiplexer 261 to the latch 264. Triggered by the clock signal clk, the latch 264 outputs the signal “F−1”, such that the signal F is decreased by 1. That is, when data is read from the TS buffer unit 100, the available packets buffered in the TS buffer unit 100 is decreased by 1, so the signal F is decreased by 1.

FIG. 4F shows a signal timing diagram of the output packet generation unit 200F according to the embodiment of the present disclosure. The output packet generation unit 200F generates output packets. Referring to FIG. 3 and FIG. 4F. The output packet generation unit 200F includes a multiplexer 285 and a latch 289. When the signal C1 occurs, the multiplexer 285 outputs the signal 48 to the latch 289. Triggered by the clock clk, the latch 289 outputs the output signal of the multiplexer 285 as the signal 50.

FIG. 4G shows a signal timing diagram of the clock generation unit 200G according to the embodiment of the present disclosure. The clock generation unit 200G generates the clock signal MPCLK_out. Referring to FIG. 3 and FIG. 4G. The clock generation unit 200G includes logic gates 292, 295 and 299, and a latch 298.

At timing T41, the signal C1 is transited to logic 1 but the signal C2 is logic 0. Therefore, due to the logic computation performed by the logic gates 292, 295 and 299, the logic gate 295 outputs logic 1 to the latch 298.

At timing T42, triggered by the clock clk, the latch 298 outputs logic 1, so the signal MPCLK_out is set as 1.

At timing T43, the signal C2 is transited to logic 1 but the signal C1 is logic 0. Therefore, due to the logic computation performed by the logic gates 292, 295 and 299, the logic gate 295 outputs logic 0 to the latch 298.

At timing T44, triggered by the clock clk, the latch 298 outputs logic 0, so the signal MPCLK_out is set as 0. That is, when signal C1 occurs, the signal MPCLK_out is set as 1 (i.e. the signal C1 may be regarded as a clock set signal), and when the signal C2 occurs, the signal MPCLK_out is reset as 0 (i.e. the signal C2 may be regarded as a clock reset signal).

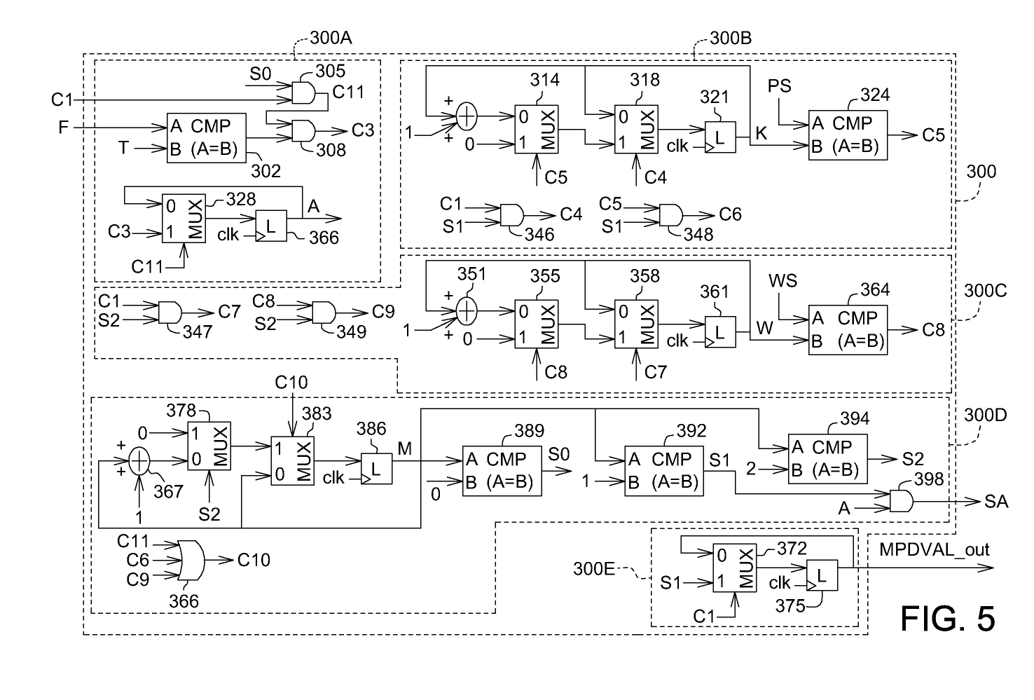

Referring to FIG. 5, a schematic diagram of the FSM 300 according to the embodiment of the present disclosure is shown. As indicated in FIG. 5, the FSM 300 includes a determination unit 300A, a packet output number counter 300B, a wait period counter 300C, an FSM control unit 300D, and a data validity indicator 300E. In the embodiment of the present disclosure, the FSM 300 has three states, namely, an idle state S0, a transfer state S1 and a wait state S2.

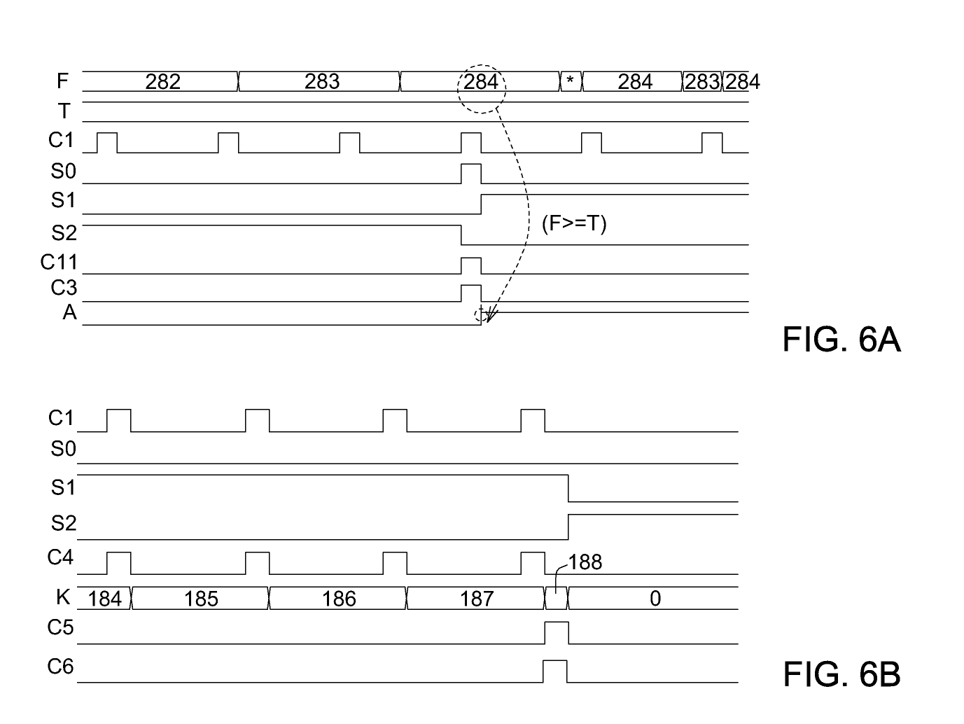

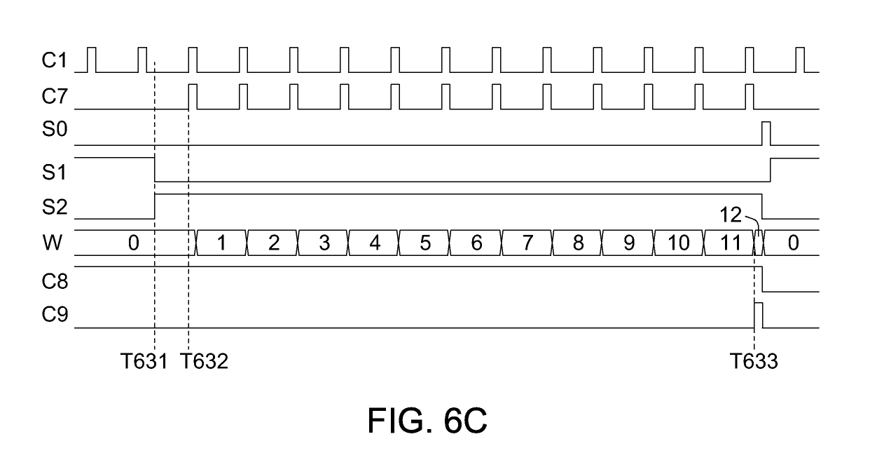

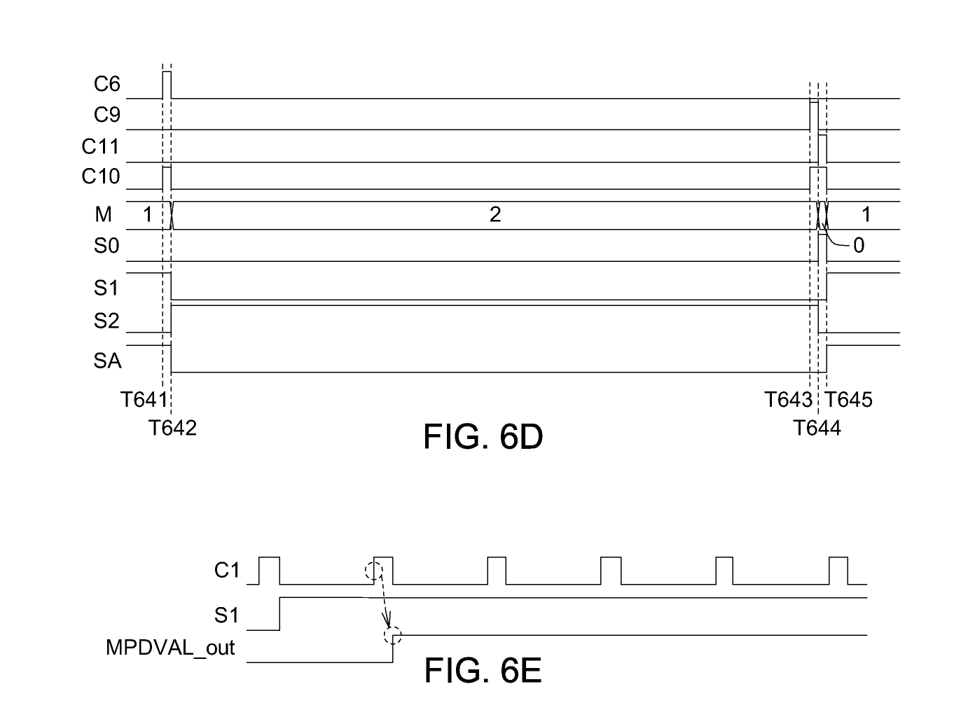

FIG. 6A shows a signal timing diagram of the determination unit 300A according to the embodiment of the present disclosure. The determination unit 300A determines whether the number of available packets buffered in the TS buffer unit 100 is larger than the threshold T when the FSM 300 enters the transfer state S1 from the idle state S0, for determining whether to provide data read from the TS buffer unit 100 to the control logic 200 or to provide the null packet streams generated by the null packet stream generation unit 45 to the control logic 200. The determination unit 300A includes logic gates 305 and 308, a comparer 302, a multiplexer 328 and a latch 366.

When the FSM 300 enters the transfer state S1 from the idle state S0, the signals C1 and S0 occur concurrently, so the logic gate 305 outputs a logic-1 signal C11 to the logic gate 308. The logic gate 308 receives the comparison result from the comparer 302. When the signal F is larger than the threshold T, the comparer 302 outputs logic 1, and vice versa.

Let FIG. 6A be taken for example. When the signal S0 occurs, “F” is 284 (suppose “T” equals 188), so the comparer 302 outputs logic 1, and the signal C3 is logic 1. Since the signal C11 is logic 1, the multiplexer 328 selects the signal C3 (logic 1) to the latch 366. Triggered by the clock signal clk, the latch 366 outputs a logic-1 signal A, which indicates that the number F of available packets buffered in the TS buffer unit 100 is larger than threshold T when the FSM 300 enters the transfer state S1 from the idle state S0 as indicated in FIG. 6A.

FIG. 6B shows a signal timing diagram of the packet output number counter 300B according to the embodiment of the present disclosure. The packet output number counter 300B counts and checks whether the packet output number K has reached a threshold PS. If yes, the FSM 300 enters the wait state S2 from the transfer state S1. The packet output number counter 300B includes logic gates 330 and 335, an adder 311, multiplexers 314 and 318, a latch 321 and a comparer 324. Thus, when “K” is equal to the parameter PS, this indicates that the packet output number K reaches the threshold PS, so the FSM 300 enters the wait state S2 from the transfer state S1.

The signal C1 indicates whether the one period of the clock signal MPCLK_out has been elapsed. Given that the FSM 300 is in the transfer state S1, if the signal C1 occurs, then the logic gate 346 outputs a logic-1 signal C4. The adder 311, the multiplexers 314 and 318 and the latch 321 count up the parameter K until the parameter K is equal to the parameter PS. Detailed descriptions are given below.

When the parameter K has not yet reached the parameter PS, the comparer 324 outputs a logic-0 signal C5, so the multiplexer 314 outputs “K+1” (that is, the result of addition computation performed by the adder 311) to the multiplexer 318. Since the signal C4 is logic 1, the multiplexer 318 outputs the output signal “K+1” of the multiplexer 314 to the latch 321 to count up the parameter K until the parameter K reaches the parameter PS.

When the parameter K reaches the parameter PS, the comparer 324 outputs a logic-1 signal C5, so the multiplexer 314 outputs “0” to the multiplexer 318. Since the signal C4 is logic 1, the multiplexer 318 outputs “0” to the latch 321 to reset the parameter K as 0. When the signal C5 is logic 1, the logic gate 348 outputs a logic-1 signal C6. The logic-1 signal C6 is related to the transition of the signal S1 to logic 0 and the transition of the signal S2 to logic 1, which indicates that the FSM 300 enters the wait state S2 from the transfer state S1. The detailed descriptions are disclosed below.

FIG. 6C shows a signal timing diagram of the wait period counter 300C according to the embodiment of the present disclosure. The wait period counter 300C includes logic gates 347 and 349, an adder 351, multiplexers 355 and 358, a latch 361 and a comparer 364. The wait period counter 300C counts a period number W during which the FSM 300 is in the wait state S2, to determine whether to switch the FSM 300 to the idle state S0 from the wait state S2, for example to save power consumption.

Referring to FIG. 5 and FIG. 6C. At timing T631, the signal C1 is logic 0, the signal C8 is logic 0, the signal S1 is transited to logic 0 and the signal S2 is transited to logic 1, so the logic gate 347 outputs a logic-0 signal C7 and the logic gate 349 outputs a logic-0 signal C9. Since the signal C7 is logic 0, the multiplexer 358 selects “W” to the latch 361. That is, at timing T631, “W” is maintained.

At timing T632, the signal C1 is transited to logic 1, the signal C8 is logic 1, the signal S1 is logic 0 and the signal S2 is logic 1, so the logic gate 347 outputs a logic-1 signal C7 and the logic gate 349 outputs a logic-0 signal C9. Since the signal C8 is logic 1, the multiplexer 355 selects “W+1” (that is, the result of addition computation performed by the adder 351) to the multiplexer 358. Since the signal C7 is logic 1, the multiplexer 355 selects the output “W+1” of the multiplexer 355 to the latch 361. That is, at timing T632, “W” is counted up. “W” is counted up until W=WS. Here, WS=12 is taken for example.

At timing T633, since “W” is equal to “WS”, the comparer 364 outputs a logic-1 signal C8, and accordingly the signal C9 becomes logic 1. Since the signal C8 is logic 1, the multiplexer 355 selects “0” to the multiplexer 358, so that “0” enters the latch 361 via the multiplexer 358 to reset “W” as 0. Transition of the signal C9 to logic 1 is related to switching the FSM 300 to the idle state S0 from the wait state S2, and the details are disclosed below.

As indicated in FIG. 6C, in the embodiment of the present disclosure, when the wait period counter 300C counts that the period number W during which the FSM 300 is in the wait state S2 reaches the threshold WS, the FSM 300 is switched to the idle state S0 from the wait state S2.

FIG. 6D shows a signal timing diagram of the FSM control unit 300D according to the embodiment of the present disclosure. The FSM control unit 300D includes logic gates 366 and 398, an adder 367, multiplexers 378 and 383, a latch 386, and comparers 389, 392 and 394. The FSM control unit 300D controls the state of the FSM 300, and outputs the signal SA.

Referring to FIG. 5 and FIG. 6D. At timing T641, since signal C6 is transited to logic 1 (this indicates that the packet output number is equal to the threshold T as indicated in FIG. 6B), the logic gate 366 outputs a logic-1 signal C10. Since the signal S2 is logic 0, the multiplexer 378 selects “M+1” to the multiplexer 383. Since the signal C10 is logic 1, the multiplexer 383 selects the output signal “M+1” of the multiplexer 378 to the latch 386. Therefore, at timing T642, “M” is counted up to 2 from 1, and the comparer 394 outputs the logic-1 signal S2, which indicates that the FSM 300 enters the wait state S2 from the transfer state S1.

At timing T643, since the signal C9 is transited to logic 1 (this indicates that the wait period number during which the FSM 300 is in the wait state S2 reaches the threshold WS as indicated in FIG. 6C), the logic gate 366 outputs a logic-1 signal C10. Since the signal S2 is logic 1, the multiplexer 378 selects “0” to the multiplexer 383. Since signal C10 is logic 1, the multiplexer 383 selects the output signal “0” of the multiplexer 378 to the latch 386. Thus, at timing T644, “M” is reset as 0 and the comparer 389 outputs a logic-1 signal S0, which indicates that the FSM 300 enters the idle state S0 from the wait state S2.

At timing T645, since the signal C11 is transited to logic 1 (this indicates that the FSM 300 enters the transfer state S1 from the idle state S0 as indicated in FIG. 6A), the logic gate 366 outputs a logic-1 signal C10. Since the signal S2 is logic 0, the multiplexer 378 selects “M+1” to the multiplexer 383. Since the signal C10 is logic 1, the multiplexer 383 selects the output signal “M+1” of the multiplexer 378 to the latch 386. Thus, at timing T645, “M” is counted up to 1 from 0, and the comparer 392 outputs a logic-1 signal S1, which indicates that the FSM 300 enters the transfer state S1 from the idle state S0. Given that the signal S1 is logic 1 (this indicates that the FSM 300 enters the transfer state S1), if the signal A is logic 1 (this indicates that the number of packets buffered in the TS buffer unit 100 is larger than the available packet threshold T as indicated in FIG. 6A), then the signal SA is logic 1 and the multiplexer 47 outputs the output data of the TS buffer unit 100. To the contrary, given that signal S1 is logic 1 (this implies that the FSM 300 enters the transfer state S1), if the signal A is logic 0 (this implies that the number of packets buffered in the TS buffer unit 100 is smaller than the available packet threshold T), then the logic gate 398 outputs a logic-0 signal SA and the multiplexer 47 outputs the null packet streams provided by the null packet stream generation unit 45.

FIG. 6E shows a signal timing diagram of the data validity indicator 300E according to the embodiment of the present disclosure. The data validity indicator 300E includes a multiplexer 372 and a latch 375. When or after the signal S1 is transited to logic 1 (that is, when or after the FSM 300 enters the transfer state S1), this indicates that the control logic 200 already outputs packets. Therefore, when the signal C1 is transited to logic 1 and the signal S1 is logic 1, the multiplexer 372 outputs the signal S1 (logic 1) to the latch 375. Triggered by the clock signal clk, the latch 375 outputs a logic-1 signal MPDVAL_out, which indicates that the control logic 200 outputs a valid packet, which may include signals MPDATA_in, MPERR_in and MPSTR_in of the signal TSR1, or include null packet streams.

In the embodiment of the present disclosure, when transferring a packet to the descrambler 5, regardless the bit rate of the signal transferred from the tuner 1 and the demodulator 2 is changed or not, the TS bit rate control unit 4 maintains the bit rate of the TS signal, such that the descrambler 5 is less likely to have error operations which occurs due to the change in the bit rate of the TS signal.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A video signal processing circuit, comprising:
a transport stream (TS) decoding unit for decoding a demodulated analog radio frequency (RF) signal to generate a first TS signal; and
a TS bit rate control unit coupled to the TS decoding unit for determining whether to insert a null packet stream to the first TS signal to generate a second TS signal according to a bit rate of the first TS signal.

2. The video signal processing circuit according to claim 1, wherein the TS bit rate control unit comprises:
a TS buffer unit for buffering a packet signal of the first TS signal;
a control logic for generating an operation control signal, an address signal, a multiplexer control signal, a clock signal of the second TS signal and a data validity indicating signal of the second TS signal based on a clock signal of the first TS signal and a data validity indicating signal of the first TS signal;
a null packet stream generation unit for generating the null packet stream; and
a multiplexer coupled to the TS buffer unit, the control logic and the null packet stream generation unit, for transferring at least one of the packet signal of the first TS signal buffered in the TS buffer unit and the null packet stream to the control logic according to the multiplexer control signal generated by the control logic;
wherein, the TS buffer unit performs a read/write operation according to the operation control signal and the address signal generated by the control logic; and
wherein, if the control logic determines that the number of available packets buffered in the TS buffer unit is larger than an available packet threshold, the control logic determines that the TS buffer unit provides the packet signal of the second TS signal, otherwise, the control logic determines that the null packet stream generation unit provides the packet signal of the second TS signal.

3. The video signal processing circuit according to claim 2, wherein, the control logic comprises:
a write control signal generation unit coupled to the TS decoding unit, for generating a write control signal to the TS buffer unit to control a write operation of the TS buffer unit based on a plurality of sampling signals of the clock signal of the first TS signal and the data validity indicating signal of the first TS signal.

4. The video signal processing circuit according to claim 3, wherein, the control logic further comprises:
a write address generation unit coupled to the write control signal generation unit, wherein when the write control signal occurs, the write address generation unit progressively increases a write address which controls the write operation of the TS buffer unit, and when the write address reaches an upper limit, the write address generation unit resets the write address.

5. The video signal processing circuit according to claim 4, wherein, the control logic further comprises:
a read control signal generation unit for progressively increasing a parameter, the read control signal generation unit generating a clock set signal and a clock reset signal according to a relationship between the parameter and a clock, and generating a read control signal to control a read operation of the TS buffer unit according to the clock reset signal and the multiplexer control signal.

6. The video signal processing circuit according to claim 5, wherein, the control logic further comprises:
a read address generation unit coupled to the read control signal generation unit, wherein when the read control signal occurs, the read address generation unit progressively increases a read address which controls the read operation of the TS buffer unit, and when the read address reaches an upper limit, the read address generation unit resets the read address.

7. The video signal processing circuit according to claim 6, wherein, the control logic further comprises:
an available packet number indicator coupled to the write control signal generation unit and the read control signal generation unit;
when the TS buffer unit is written, the available packet number indicator progressively increases an available packet indication number;
when the TS buffer unit is read, the available packet number indicator progressively decreases the available packet indication number.

8. The video signal processing circuit according to claim 7, wherein, the control logic further comprises:
an output packet generation unit coupled to the multiplexer, wherein when the clock set signal occurs, the output packet generation unit generates the packet signal of the second TS signal based on an output signal of the multiplexer.

9. The video signal processing circuit according to claim 8, wherein, the control logic further comprises:
a clock generation unit coupled to the read control signal generation unit;
when the clock set signal occurs, the clock generation unit sets the clock signal of the second TS signal; and
when the clock reset signal occurs, the clock generation unit resets the clock signal of the second TS signal.

10. The video signal processing circuit according to claim 9, wherein, the control logic further comprises:
a finite state machine (FMS) coupled to the write control signal generation unit and the available packet number indicator, for generating the multiplexer control signal and the data validity indicating signal of the second TS signal according to the clock set signal and the available packet indication number, wherein the FMS has an idle state, a transfer state and a wait state.

11. The video signal processing circuit according to claim 10, wherein, the FMS comprises:
a determination unit coupled to the write control signal generation unit and the available packet number indicator, wherein when the FMS enters the transfer state from the idle state, the determination unit determines whether the number of available packets buffered in the TS buffer unit is larger than the available packet threshold.

12. The video signal processing circuit according to claim 11, wherein, the FMS comprises:
a packet output counter coupled to the read control signal generation unit, for counting whether a packet output number has reached a packet output threshold, and if yes, then the FMS enters the wait state from the transfer state.

13. The video signal processing circuit according to claim 12, wherein, the FMS comprises:
a wait period counter coupled to the read control signal generation unit, for counting a period number during which the FMS is in the wait state, to determine whether the FMS enters the idle state from the wait state.

14. The video signal processing circuit according to claim 13, wherein, the FMS comprises:
a state control unit coupled to the determination unit, the packet output number counter and the wait period counter, for controlling the state of the FMS, and for outputting the multiplexer control signal according to the state of the FMS and a determination result made by the determination unit.

15. The video signal processing circuit according to claim 14, wherein, the FMS comprises:
a data validity indicator coupled to the state control unit, wherein when or after the FMS enters the transfer state, the data validity indicator generates the data validity indicating signal of the second TS signal at transition of the clock set signal.

16. A video signal processing method, comprising:
decoding a demodulated analog radio frequency signal to generate a first transport stream (TS) signal; and
determining whether to insert a null packet stream to the first TS signal to generate a second TS signal according to a bit rate of the first TS signal.

17. The video signal processing method according to claim 16, wherein, the step of generating the second TS signal comprises:
buffering a packet signal of the first TS signal;
generating an operation control signal, an address signal, a multiplex control signal, a clock signal of the second TS signal and a data validity indicating signal of the second TS signal based on a clock signal of the first TS signal and a data validity indicating signal of the first TS signal;
generating the null packet stream; and
determining whether to transfer at least one of the packet signal of the buffered first TS signal and the null packet stream according to the multiplex control signal;
performing a read/write operation on a TS buffer unit according to the operation control signal and the address signal; and
providing the packet signal of the second TS signal by the TS buffer unit if the number of the buffered available packets is larger than a available packet threshold, and otherwise, providing the packet signal of the second TS signal by the null packet stream.

18. The video signal processing method according to claim 17, further comprising:
generating a write control signal to the TS buffer unit to control a write operation of the TS buffer unit, based on a plurality of sampling signals of the clock signal of the first TS signal and the data validity indicating signal of the first TS signal.

19. The video signal processing method according to claim 18, further comprising:
progressively increasing a write address when the write control signal occurs, wherein the write address controls the write operation of the TS buffer unit; and
resetting the write address when the write address reaches an upper limit.

20. The video signal processing method according to claim 19, further comprising:
progressively increasing a parameter, and generating a clock set signal and a clock reset signal according to a relationship between the parameter and a clock;
generating a read control signal to control a read operation of the TS buffer unit, according to the clock reset signal and the multiplex control signal.

21. The video signal processing method according to claim 20, further comprising:
progressively increasing a read address when the read control signal occurs, the read address for controlling the read operation of the TS buffer unit; and
resetting the read address when the read address reaches an upper limit.

22. The video signal processing method according to claim 21, further comprising:
progressively increasing an available packet indication number in writing the TS buffer unit; and
progressively decreasing the available packet indication number in reading the TS buffer unit.

23. The video signal processing method according to claim 22, further comprising:
generating the packet signal of the second TS signal based on an output signal of the multiplexer when the clock set signal occurs.

24. The video signal processing method according to claim 23, further comprising:
setting the clock signal of the second TS signal when the clock set signal occurs; and
resetting the clock signal of the second TS signal when the clock reset signal occurs.

25. The video signal processing method according to claim 24, further comprising:
generating the multiplex control signal and the data validity indicating signal of the second TS signal according to the clock set signal and the available packet indication number.

26. The video signal processing method according to claim 25, further comprising:
determining whether the number of available packets buffered in the TS buffer unit is larger than the available packet threshold when entering a transfer state from an idle state.

27. The video signal processing method according to claim 26, further comprising:
counting and checking whether a packet output number has reached a packet output threshold; and
entering a wait state from the transfer state if yes.

28. The video signal processing method according to claim 27, further comprising:
counting a period number in the wait state to determine whether to enter the idle state from the wait state.

29. The video signal processing method according to claim 28, further comprising:
controlling a state to be in one of the idle state, the transfer state and the wait state, and outputting the multiplex control signal according to the state and a determination result regarding whether the number of available packets buffered in the TS buffer unit is larger than the available packet threshold.

30. The video signal processing method according to claim 29, further comprising:
generating the data validity indicating signal of the second TS signal at transition of the clock set signal when or after entering the transfer state.
